(19) United States
(12) Patent Application Publication
(10) Pub. No.: US 2005/0034583 A1
(43) Pub. Date: Feb. 17, 2005

(54) Paper punch apparatus

(76) Inventors: Makoto Mori, Tokyo (JP); Hiroshi Tadenuma, Tokyo (JP)

Correspondence Address: Michael S. Leonard;Bell, Boyd & Lloyd LLC, P.O. Box 1135, Chicago, IL, 60690-1135, US

(21) Appl. No.: 10/896,196

(22) Filed: Jul. 20, 2004

(30) Foreign Application Priority Data
Aug. 11, 2003 (JP) 2003-291190

(51) Int. Cl. B26D 5/08

(52) U.S. Cl. 83/588; 83/620

(57) ABSTRACT

When a bit reception plate is moved to an upper-end bit tip portion of a hole punch bit, a paper-stacking base supported by parallel link mechanisms by using a pressure force of the bit reception plate descends while maintaining a horizontal and parallel state. While paper (not shown) placed on the paper-stacking base is being intensively held by the bit reception plate and the paper-stacking base, the paper is abutted in a straight state with respect to an upper-end bit tip portion of the hole punch bit, whereby a desired number of holes can be punched into the paper. Excellent punch function, and smooth and stable discharge function of punched paper scraps with simple and inexpensive structure are secured.

### BACKGROUND OF THE INVENTION

1. Field of the Invention

The present invention relates to a paper punch apparatus capable of securely and steadily punching a document-binding hole(s) into one or more paper sheets between a bit reception plate and a tubular hole punch bit.

2. Description of the Related Art

Conventionally, various types of paper punch apparatuses that are capable of punching binding holes into, for example, one or more document paper sheets by sandwiching the document paper sheets between a resin-discoidal bit reception plate and a hole punch bit formed in a metallic-tubular state. As one of these types of paper punch apparatuses, a high power paper punch apparatus is disclosed in, for example, Japanese Patent Application Laid-Open No. 09-109098.

The paper punch apparatus described in the publication has a construction as described hereunder. An elevating unit is supported on a base unit to be vertically movable via an operating handle, and a hole punch bit is fixedly supported on the elevating unit. In a paper-stacking base fixedly mounted on the base unit, an insertion recess portion is formed in the state of being deflected with respect to the vertical line of the hole punch bit. A bit reception plate is inserted and supported rotatably in the insertion recess portion. A bit tip portion of the hole punch bit has a positional relationship with the bit reception plate to perform approaching/detaching operation with respect to the plate.

Ratchet teeth are formed around the periphery of the bit reception plate. When the elevating unit descends with the operation of the operating handle, operation pawls engaging the ratchet teeth advance in the direction opposite the rotational direction of the ratchet teeth via an interlocking mechanism working with a rotation of the operating handle. In contrast, when the elevating unit ascends with the operation of the operating handle, the operation pawls engage the ratchet teeth via the interlocking mechanism whereby to cause the bit reception plate to rotate by one pitch.

In this paper punch apparatus, the contact position between the bit reception plate and the hole punch bit can be changed each time the operating handle is operated. Therefore, the construction enables the prevention of such an event that the hole punch bit constantly abuts a same portion of the bit reception plate whereby causing a circular extracting groove on the bit reception plate. The consequence enables overcoming such shortcomings that when punching document binding holes into a plurality of paper sheets, the lowest paper sheet is stuck in the circular extracting groove caused by a bit tip portion of the hole punch bit, thereby making it impossible to take out the lowest paper sheet. Thus, according to the conventional paper punch apparatus, the bit reception plate is inserted and thereby supported so as to be intermittently self-rotatable in the insertion recess portion formed in the paper-stacking base in conjunction with the up and down movement of the elevating unit, and the tubular hole punch bit is fixedly supported on the elevating unit to perform ascending and descending motion together with the elevating unit. In the construction, the elevating unit is moved down by rotational operation of the operating handle to cause the bit tip portion of the hole punch bit to one-time push an arbitrary number of paper sheets placed over the paper-stacking base, whereby punch operation is performed.

Punched paper scraps cut out at the punching time enter the inside of the tubular hole punch bit. As punch operations are repeatedly performed, accumulated punched paper scraps in the tubular hole punch bit are sequentially lifted. The lifted punched paper scraps are guided through a discharge passageway formed in a main body of the punch apparatus and then stored into a scrap collection receptacle disposed in the main body of the punch apparatus. However, the conventional paper punch apparatus has problems. For example, at the time of ascending and descending movement of the hole punch bit, punching, changing paper sheets to be punched, or transferring the paper punch apparatus, punched paper scraps overflowed the inside of the hole punch bit and punched paper scraps remained in the hole punch bit fall from the bit tip portion of the hole punch bit and scatter around. In particular, when a large number of punched paper scraps scatter on the paper-stacking base or therearound, the paper-stacking base, a work table, and/or the like are made unclean, and the punched paper scraps adhere to peripheral mechanisms such as gears, thereby causing deterioration of workability thereof. Since punched paper scraps cause problems with paper punch work in various ways, cleaning work should be frequently done to inhibit scattering of punched paper scraps. This consequently leads to a problem that paper punch operation is caused intricate, so that the punch operation cannot be easily and quickly performed.

As described above, according to the conventional paper punch apparatus, the elevating unit should be moved down by the rotational operation of the operating handle to cause the tubular hole punch bit to perform the approaching operation to the bit reception plate disposed on the base unit. In this case, the punch operation is performed in the manner that the tubular hole punch bit is brought into close proximity with a paper set (set of paper sheets) placed on the paper-stacking base, and thereafter the bit tip portion is pushed at one time to the paper set. At the time of punch operation, it is essential that the paper set placed on the paper-stacking base is held in an immobilizable state, and the bit tip portion of the hole punch bit is then pushed into the paper set while the immobilizable state is being maintained. When the paper set cannot be maintained in the immobilizable state, a problem is likely to occur in that the individual paper sheets are misaligned whereby causing, for example, nonuniform punch hole positions and patterns.

As another example of a conventionally used paper punch apparatus, there is a paper punch apparatus in which, for example, a discoidal bit reception plate is fixedly supported on an elevating unit and a tubular hole punch bit is vertically fixed on a base unit. The paper punch apparatus is constructed such that a paper-stacking base is oscillatorily move in the vertical direction with a proximal end portion thereof as the center. When the elevating unit is moved down by the operation of an operating handle, while a paper set is being gripped between the bit reception plate and the paper-stacking base, the paper-stacking base is oscillatorily rotated to the hole punch bit vertically provided on the base unit. Thereby, punch holes are formed into the paper set clamped between the bit reception plate and the paper-stacking base.

In the paper punch apparatus of this type in which the paper-stacking base is rotated, problems occur in that, for example, the paper set is likely to move at the oscillatory movement of the paper-stacking base, and the punch position of paper with respect to the hole punch bit is misaligned, and frictional resistance of the paper set to the tubular hole punch bit is increased.

Additionally, the above-described paper punch apparatus disclosed in the official gazette has problems as described hereunder. The tubular hole punch bit vertically moving with respect to the base unit performs the approaching/detaching operation with respect to the bit reception plate immobilizably disposed on the base unit, in which it is difficult to rationally discharge paper punch scraps remaining in the tubular hole punch bit. Other problems are that, for example, paper punch scraps remaining in the tubular hole punch bit scatter, and misalignment of punch hole positions of paper and defective punch holes are likely to occur.

Even the above-described punch apparatus in which the paper-stacking base is oscillatorily rotated has, for example, a problem in that misalignment of punch hole positions of paper and defective punch holes are likely to occur. Therefore, what is strongly demanded is a paper punch apparatus that, while the structure is simple, functions such as the paper punching and punched-paper-scrap discharging are smoothly and steadily secured. If the demand is satisfied, quality improvement and cost reduction for the paper punch apparatus can be implemented.

The invention is made in view of the problems described above. Accordingly, an object of the invention is to provide a paper punch apparatus that is simply structured, that is manufacturable at low costs, that is capable of steadily and securely discharging paper punch scraps without allowing scattering thereof, and that enables implementing quality improvement, cost reduction, and the like while securing a stabilized high-performance punch function, discharge function, and the like.

### SUMMARY OF THE INVENTION

A basic construction of the present invention lies in a paper punch apparatus for forming a document binding hole(s) into one or more paper sheets between a bit reception plate and a tubular hole punch bit, being characterized in that a lower end of the hole punch bit is fixed to a base unit, and an upper-end bit tip portion of the hole punch bit is disposed so as to pierce a paper-stacking base, the bit reception plate is disposed in opposition to the upper-end bit tip portion of the hole punch bit, and the apparatus comprises a approaching/detaching means for causing the bit reception plate to perform approaching/detaching operation with respect to the bit tip portion; and the paper-stacking base comprises a moving means that moves along a movement direction of the bit reception plate in cooperation with the approaching operation of the bit reception plate.

In the construction, the moving means of the paper-stacking base preferably comprises first and second parallel link mechanisms and return spring means for the parallel link mechanisms. In addition, the construction preferably comprises a fall inhibition mechanism that is provided in an opening end portion on a base-unit support side of the hole punch bit and that inhibits falling of punched paper scraps accumulating in a cylinder of the hole punch bit. As the fall inhibition mechanism, a leaf spring member is preferably used. Further, the construction preferably comprises an elevating unit for supporting the bit reception plate, and an operation portion for vertically moving the elevating unit with respect to the upper-end bit tip portion of the hole punch bit.

The paper punch apparatus of the present invention is featured in that the tubular hole punch bit is disposed immobilizably with respect to the base unit; the bit reception plate is disposed detachably and approachably with respect to the upper-end bit tip portion of the hole punch bit; and the paper-stacking base comprises the moving means specific to the present invention that vertically moves along the same direction of the bit reception plate in cooperation with the approaching operation of the bit reception plate while maintaining a horizontal and parallel state. In this regard, the paper punch apparatus of the present invention has a greatly different construction from the conventional paper punch apparatus. According to the above-described conventional techniques disclosed in the official gazettes, the bit reception plate is fixedly supported on the immobilizable paper-stacking base, and the hole punch bit is provided in the elevating unit to be detachable and approachable with respect to the bit reception plate. Therefore, at the time of punch operation, circular punched paper scraps enter the inside of the tubular hole punch bit; and as punch operations are repeatedly performed, accumulated punched paper scraps are sequentially lifted.

As a result, problems occur in that, at the time of ascending and descending of the hole punch bit, punching, changing a paper set to be punched, or transferring the paper punch apparatus, punched paper scraps overflowed the inside of the hole punch bit, and punched paper scraps accumulating in the hole punch bit fall from the bit tip portion of the hole punch bit and scatter toward the paper-stacking base.

According to the present invention, since the tubular hole punch bit is disposed immobilizably with respect to the base unit, punched paper scraps accumulated in the hole punch bit can be sequentially pushed down to fall and can thereby be stored in a scrap collection receptacle. Consequently, punched paper scraps do not fall and scatter to, for example, the paper-stacking base and peripheral portions thereof, so that punched paper scraps can be prevented from, for example, making portions such as the paper-stacking base and the peripheral portions thereof to be unclean and adhering to a peripheral mechanism whereby deteriorating the operability thereof. Accordingly, cleaning work for paper need not be frequently done, and the punching operation into one or more paper sheets can be quickly, smoothly, and easily performed.

In the conventional punch apparatus in which the paper-stacking base has the base-portion rotation center, problems occur in that, for example, in association with the oscillatory movement of an oscillating end of the paper-stacking base, the punch position of a paper set is misaligned, or the frictional resistance with respect to the tubular hole punch bit is increased.

In comparison, according to the present invention, when the bit reception plate approaches by the moving means, to-be-punched paper sheets are held between the paper-stacking base and the bit reception plate by using the pressure force from the bit reception plate in abutment with the paper sheets placed on the paper-stacking base. In this state, while the paper-stacking base is being maintained in a horizontal and parallel state, the to-be-punched paper sheets are punched in cooperation with the hole punch bit.

Accordingly, an arbitrary number of paper sheets placed on the paper-stacking base can be stably moved while paper sheets are being maintained in a horizontal and parallel state with respect to the upper-end bit tip portion of the hole punch bit. In this case, the to-be-punched paper sheets are intensively vertically clamped between the bit reception plate and the paper-stacking base, and the paper sheets are descended together with tile paper-stacking base while the horizontal and parallel state is being maintained, and the paper sheets are punched by the hole punch bit.

Consequently, positional error of the paper punch position can be prevented. Further, not only for a large number of stacked paper sheets, but also for a single paper sheet, the frictional resistance of paper with respect to the hole punch bit can be reduced. Accordingly, the paper can be punched firmly, securely, and simultaneously in series.

The approaching/detaching means, which enables the bit reception plate to be detachable and approachable with respect to the bit tip portion of the hole punch bit, may be of any structure inasmuch as the structure is capable of approaching and detaching the bit reception plate with respect to the hole punch bit. For example, the approaching/detaching means may be constructed as an interlocking mechanism in which operation of a handle is associated with mechanical driving mechanisms constituted of, for example, a rack-and-pinion combination, a rack-and-wormgear combination, ball-screw-and-nut combination, and link mechanism. Alternatively, the approaching/detaching means may be constructed by using actuators of hydraulic pressure, pneumatic pressure, and electric types.

For the parallel link mechanisms of the present invention, mechanisms constructed of first and second parallel link mechanisms may be employed. By way of an example of the individual parallel link mechanisms, central portions of first and second links are pin-connected, and the individual links are formed to intersect with each other in the form the letter “X.” The parallel links of this type may be employed, whereby the vertical movement of the paper-stacking base can be maintained in a horizontal and parallel state with respect to the base unit.

The construction may be arranged such that two points of end portions vertically adjacent in the first and second links are individually supported as static kinematic points on the base unit and the paper-stacking base, and the other two points are individually supported as dynamic kinematic points to be slidable in the longitudinal direction of the paper-stacking base and the base unit. As other example parallel link mechanisms, the construction may employ parallel link mechanisms using in series two sets of two links formed such that dynamic kinematic points of first and second links are coupled and are bent.

For the return spring means for each of the links, a spring such as a tension spring or compression spring may be used. The mounting position and the like of the return spring can be appropriately set corresponding to the type, structure, and the like of each parallel link mechanism. Thereby, smooth rotation of each link can be ensured in accordance with the spring force of the return spring means.

With the link mechanisms constructed as described above, at the time of approach of the bit reception plate, the paper-stacking base can be descended overall with a pressure force transferred via a paper set from the bit reception plate while maintaining the horizontal and parallel state. In association with the descendent movement of the bit reception plate, a paper sheet or a paper set placed on the paper-stacking base can be moved down together with the paper-stacking base while the horizontal and parallel state is being maintained with respect to the base unit without causing the paper placement position to be changed. The paper or paper set placed on the paper-stacking base are abutted on the hole punch bit and punched according to the pressure force transferred from the bit reception plate.

Accordingly, straight punch holes can be formed into the paper at desired position without positional misalignment. Although the parallel link mechanisms are simply structured, regardless of the number of paper sheets stacked on the paper-stacking base, the paper can be securely punched at a stable position with respect to the hole punch bit by the depression force of the bit reception plate transferred via the paper placed on the paper-stacking base. Consequently, a force sufficient to form punch holes can be provided, and one or more paper sheets can be accurately punched. This enables implementing quality improvement and cost reduction for the paper punch apparatus.

By way of a preferable example of the fall inhibition mechanism to be applied to the paper punch apparatus of the present invention, the construction may be formed as described hereunder. For example, the base unit is formed as being a case of which an end portion in a longitudinal direction is opened, and a scrap collection receptacle is removably stored in the case. The position of a base-unit opening formed in a lower portion of the hole punch bit fixed to the base unit is overlapped with the position of an opening formed in the scrap collection receptacle to cause punched paper scraps to fall. In addition, a free end portion of a leaf spring member is disposed to extend between the base-unit opening and the opening at a base-end side of the lower end of the hole punch bit. In this manner, the fall inhibition mechanism can be constructed by using the leaf spring member. In this case, the free end portion of the leaf spring member is preferably bent down and interposed in the base unit.

With the above-described construction being provided, punched paper pushed into the hole punch bit to be about to fall are accumulated on an upper surface of the leaf spring member, whereby falling of punched paper scraps can be inhibited by the spring force of the leaf spring member. As paper-hole punching operations are repeatedly performed and a predetermined quantity of punched paper scraps is accumulated, the punched paper scraps accumulated in the hole punch bit overcome the spring force of the leaf spring member whereby causing the free end portion of the leaf spring member to deflect down. While causing the leaf spring member to defect down, the punched paper scraps fall from an end of the base-end-side opening of the hole punch bit. The fallen punched paper scraps can be directly stored into the scrap collection receptacle having the opening formed in the lower portion of the base-end-side opening end.

The above-described fall inhibition mechanism is constructed such that the hole punch bit is fixedly mounted to the base unit, and the paper-stacking base is enabled to perform the elevational motion while maintaining the horizontal and parallel state. With this construction, the fall inhibition mechanism becomes capable of sufficiently exhibiting the function for the first time. Thus, falling of punched paper scraps accumulating in the hole punch bit can be inhibited through the leaf spring member. Consequently, at the time of, for example, hole punch operation, exchanging of the hole punch bit, or withdrawal of the scrap collection receptacle, punched paper scraps accumulating in the hole punch bit can be securely prevented from falling and scattering to the outside from the hole punch bit. Concurrently, punched paper scraps can be prevented from adhering to a peripheral mechanism of the apparatus whereby deteriorating the operability thereof.

Consequently, for example, the paper-stacking base, a work table, and peripheral portions thereof can be maintained cleaned at all times. Further, the operability of the paper punch apparatus, the efficiency of paper punch operation, and the like can be improved. Further, the opening end portion on the base-unit support side of the hole punch bit and the scrap collection receptacle can be vertically disposed in close proximity to each other. This consequently enables miniaturization, reduction in size, and the like of the overall apparatus to be securely implemented.

### BRIEF DESCRIPTION OF THE DRAWINGS

FIG. 1 a schematic overall side view showing a vertical cutaway of major portions of a paper punch apparatus representing a typical embodiment according to the present invention;

FIG. 2 is a perspective view showing a stale where components constituting the paper punch apparatus are separated;

FIG. 3 is a rear view of the paper punch apparatus;

FIG. 4 is an explanatory view schematically showing a modified example of a parallel link mechanisms of the paper punch apparatus;

FIG. 5 is a major-portion vertical cross sectional view showing a vertical cutaway of major portions of an elevating unit of the paper punch apparatus;

FIG. 6 is a cross sectional view taken along the line VI-VI of FIG. 5;

FIG. 7 is a major-portion vertical sectional view showing a vertical cutaway of major portions of a hole punch bit support of the paper punch apparatus;

FIG. 8 is a plan view of the hole punch bit support of the paper punch apparatus;

FIG. 9 is a rear view of the hole punch bit support;

FIG. 10 is a major-portion transverse sectional view schematically showing a transverse cutaway of major portions of an automatic rotation mechanism for a bit reception plate of the paper punch apparatus;

FIG. 11 is a side view of a scrap collection receptacle of the paper punch apparatus;

FIG. 12 is a plan view of the scrap collection receptacle;

FIG. 13 is a transverse sectional view schematically showing a laid-down state of a paper abutment member of the paper punch apparatus;

FIG. 14 is a major-portion vertical sectional view schematically showing an erected state of the paper abutment member; and

FIG. 15 is a major-portion vertical sectional view schematically showing a laid-down state of the paper abutment member.

### DESCRIPTION OF THE PREFERRED EMBODIMENTS

Preferred embodiments according to the present invention will be described below with reference to the accompanying drawings.

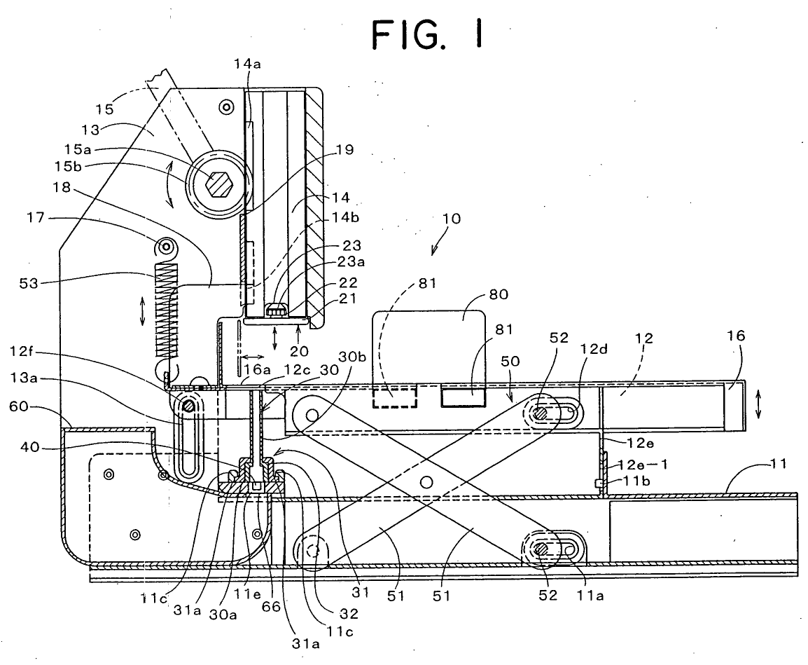

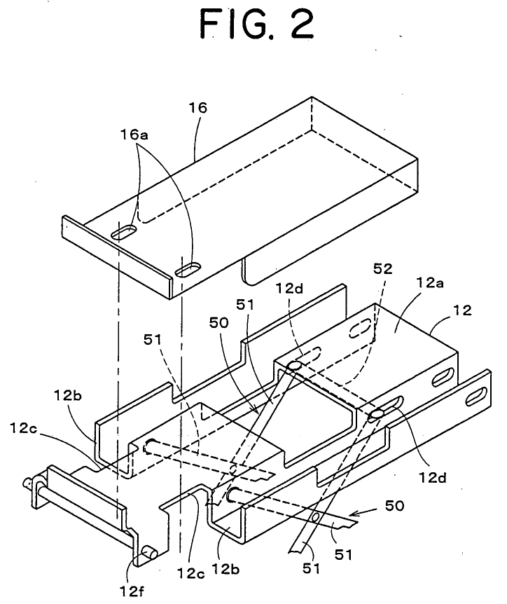

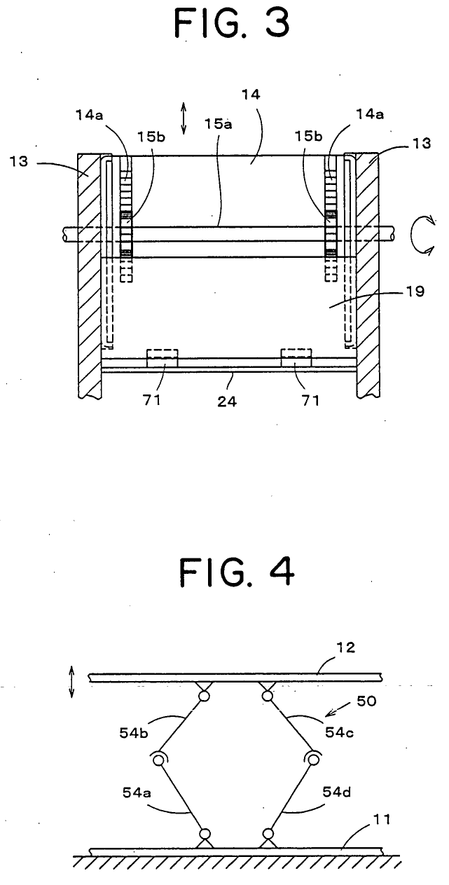

FIG. 1 a schematic overall side view showing a vertical cutaway of major portions of a paper punch apparatus representing a typical embodiment according to the present invention. FIG. 2 is a perspective view showing a state where components constituting the paper punch apparatus are separated. FIG. 3 is a schematic rear view of the paper punch apparatus. Although the present embodiment is described with reference to an example of a paper punch apparatus in which a pair of bit reception plates are each provided to be relatively movable with respect to an upper-end bit tip portion of a hole punch bit, the present invention is not limited thereto. For example, the present invention may be applied to a paper punch apparatus in which one or more bit reception plates are each provided to be relatively movable with respect to an upper-end bit tip portion of a hole punch bit.

By way of an example of the apparatus, FIG. 1 shows a punch apparatus 10 that forms document-binding holes into one or more paper sheets between discoidal bit reception plates 20 and each tubular hole punch bits 30. The punch apparatus 10 has a base unit 11 having a form of a rectangular parallelepiped longitudinally extending in the backward-forward direction; a paper-stacking base 12 mounted on an upper portion of the base unit 11 to be vertically movable; a pair of supporting walls 13, 13 erected in rear end portions (left side in FIG. 1) of the base unit 11; an elevating unit 14 guided and supported along opposite faces of each supporting wall 13 to be vertically movable; and an operating handle 15 substantially in a reverse U shape for vertically moving the elevating unit 14.

A bit reception plates 20 (21 to 23) are disposed by being inserted in insertion openings 24a (FIG. 10) individually formed in both left and right wall portions in lower end portions of the elevating unit 14, more specifically in both left and right wail portions disposed in lower end portions in the direction perpendicular to the paper surface of FIG. 1. A lower end of a hole punch bit 30 is fixed to the base unit 11, and the upper-end bit tip portion thereof is disposed so as to extend through the paper-stacking base 12.

Referring to FIG. 2, the paper-stacking base 12 has a pair of sidewall portions 12b, 12b on both left and right sides each having a substantially U form bent at multi-steps in the same direction as a part of both side portions extending along the longitudinal direction of an upper wall portion 12a in a planner state. The paper-stacking base 12 is formed of a metal plate of which a vertical cross section has a substantially Ω form. On the upper wall portion 12a, a metal cover 16 having a substantially transverse C cross sectional shape is disposed movable forwardly and rearwardly in the longitudinal direction. A portion between opposite faces of the individual sidewall portions 12b of the paper-stacking base 12 forms a guide rail portion that inductively guides left and right sidewall portions of the metal cover 16.

In both side end faces on a rear side along the longitudinal direction of the paper-stacking base 12, there are formed recessed cutout portions 12c, 12c inwardly formed to avoid interference with the hole punch bits 30. In addition, linear and circularly arcuate lengthy openings 16a are individually formed on positions corresponding to the recessed cutout portions 12C of the metal cover 16. Similar to a recessed cutout portion 12c, an arcuate lengthy opening 16a forms an inductive guide space for avoiding interference with the hole punch bit 30 in the event that the metal cover 16 moves along the longitudinal direction of the paper-stacking base 12.

Most essential features of the present invention are that the lower end of the hole punch bit 30 is immobilizably disposed on the base unit 11, that the bit reception plate 20 is disposed approachable and detachable with respect to the upper-end bit tip portion of the hole punch bit 30, and that the paper-stacking base 12 has a moving means for ascending and descending while constantly maintaining a parallel state with respect to the base unit 11.

The hole punch bit 30 is formed of a proximal end portion 30a having a large-diameter cylindrical structure, and a small-diameter cylindrical rod portion 30b formed in the proximal end portion 30a so as to extend along a central axis. The inside diameter of the proximal end portion 30a is set larger than the inside diameter of the rod portion 30b. An upper-end inner circumferential surface of the rod portion 30b forms a bit face having a sharp tip formed with a tapered face upwardly inclining to the outer side. The upper-end bit tip portion is disposed to extend through the recessed cutout portions 12c of the paper-stacking base 12 and the arcuate lengthy opening 16a of the metal cover 16. One of the bit reception plates 20 is formed of a large-diameter discoidal main body 21, a supporting axis 22 extending along a central axial line of the main body 21, and a flange portion 23 fixed in an axial end portion of the supporting axis 22. A tip of the flange portion 23 has a substantially decapitated conical shape. A gear 23a is formed on an outer circumference of the flange portion 23. Individual central axial lines of the main body 21, supporting axis 22, and flange portion 23 are positioned along the same vertical line. The bit reception plate 20 is disposed to oppose an eccentric position with respect to the upper-end bit tip portion of the hole punch bit 30 and to be rotatable about the vertical axial line.

The elevating unit 14 and an operation portion are provided as an approaching/detaching means for causing the bit reception plate 20 to perform the approaching/detaching operation with respect to the upper-end bit tip portion of the hole punch bit 30. For the operation portion, mechanical driving mechanisms such as a rack-and-wormgear mechanism, ball-screw-and-nut mechanism, and link mechanism may be used as an interlocking mechanism arranged to operate in association with the operation of the operating handle 15. Alternatively, the operation portion may be constructed by using various actuators of hydraulic pressure, pneumatic pressure, and electric types. Thus, the operation portion may be of any type inasmuch as the portion has a construction capable of transmitting an approaching force of the bit reception plate 20 to the hole punch bit 30, so that the present invention is not limited to the specific embodiment.

In the present embodiment, the operating handle 15, which partly constitutes the operation portion, is fixedly supported by exposed end portions of a rotation axis 15a transversely supported between the supporting walls 13 to be freely rotatable. As shown in FIG. 3, a pair of pinion gears 15b, 15b are fixed with both end portions of the rotation axis 15a extending between opposite faces of the supporting walls 13. A pair of left and right linear rack gears 14a, 14a individually engaging the pinion gears 15b, 15b are fixed with the elevating unit 14. Consequently, when the operating handle 15 is rotated clockwise as viewed in FIG. 1, the elevating unit 14 moves down along the portion between the opposite faces of the supporting walls 13. When the operating handle 15 is rotated counterclockwise as viewed in FIG. 1, the elevating unit 14 moves up along the portion between the opposite faces of the supporting walls 13.

The moving means according to the typical embodiment of the present invention is constructed as shown in FIGS. 1 and 2. The moving means is formed of a pair (two sets) of first and second parallel link mechanisms 50, 50 individually disposed parallel with each other between the base unit 11 and the paper-stacking base 12. The two sets of parallel link mechanisms 50 have the same construction, so that only one set of the parallel link mechanisms 50 is described below. The other set of parallel link mechanisms 50 is shown with the same member characters or numerals, but detailed description thereof is omitted herefrom.

Each parallel link mechanism 50 is constructed of an X-shaped parallel links formed such that intermediate portions of first and second links 51, 51 are pin coupled so that the individual links 51 intersect with each other. With this construction, the vertical movement of the paper-stacking base 12 can be maintained in a horizontal and parallel state with respect to the base unit 11.

Two points of end portions vertically adjacent in the links 51 of the each set are supported on the base unit 11 and the paper-stacking base 12 as static kinematic points to be freely rotatable. Accordingly, other two points of free end portions are dynamic kinematic points. The dynamic kinematic points of the links 51 of each set are individually fixed with supporting rods 52, 52. Transversely long circularly arcuate lengthy openings 11a and 12d are formed in left and right sidewall portions along the longitudinal direction of the base unit 11 and the paper-stacking base 12. In addition, both side end portions of the supporting rods 52 of each set are supported in the transversely long circularly arcuate lengthy openings 11a and 12d to be forwardly and rearwardly slidable along the longitudinal direction.

In addition, a tension spring as a return spring means 53 for standing the parallel link mechanism 50 is interposed between a linear bar member 17 extending between the individual supporting walls 13 and a rear end of the paper-stacking base 12. The mounting position, mounting number, and the like of the return spring means can be appropriately set corresponding to the type, structure, and the like of the each parallel link mechanism 50. Thereby, smooth rotation of the each link can be ensured. For the return spring means of the link of the each set, for example, a compression spring can be used, or alternatively, a compression spring and a tension spring can be individually used.

FIG. 4 schematically shows a modified example of parallel link mechanisms. As another preferred example, parallel link mechanisms 50 as shown in FIG. 4 may be used. The parallel link mechanisms 50 are formed such that dynamic kinematic points of first and second links 54a and 54b are coupled, and two bent links are serially arranged. Also in the case of the modified example, the same structure are used in left and right sets. Each parallel link mechanism 50 is structured as described hereunder. One-side ends of the first and second links 54a and 54b are rotatably supported as static kinematic points on the base unit 11 and paper-stacking base 12. Then, other third and fourth links 54c and 54d opposite in parallel with each other are disposed on the same vertical plane with respect to the two links oppositely bent to intersect with each other with free ends of the links 54a and 54b as dynamic kinematic points. The dynamic kinematic points are configured so as to vertically move in parallel with each other. For the return spring means, a desired number of springs may be appropriately mounted on mounting positions.

Description below will discuss an embodiment using two sets of parallel link mechanisms 50. However, the number of the parallel link mechanisms is not limited to two, but the present invention can be enforced by using at least one set of the parallel link mechanisms.

At the time of approach of the bit reception plate 20, the parallel link mechanisms 50 make the paper-stacking base 12 descend by means of a pressure force generated with the descent of the elevating unit 14 and transferred from the bit reception plate 20, and the paper-stacking base 12 descends together with an arbitrary number of to-be-punched paper sheets (not shown) placed on the paper-stacking base 12 while maintaining the horizontal and parallel state with respect to the base unit 11. At the time of descent of the paper-stacking base 12, while to-be-punched paper sheets (not shown) placed on the paper-stacking base 12 are being intensively vertically clamped between the metal cover 16, which partly constitutes the paper-stacking base 12, and the bit reception plate 20, the paper sheets are punched by the hole punch bit 30.

The paper can be abutted linearly with respect to the axial direction of the hole punch bit 30, so that without causing a positional error in the paper punch position, punch holes can be formed linearly in desired positions and can be securely formed. Although the parallel link mechanisms 50 are simply structured, paper placed on the metal cover 16 can be pressed linearly with respect to the hole punch bit 30, smoothly and steadily by using the pressure force of the bit reception plate 20. Consequently, an arbitrary number of paper sheets can be accurately and neatly punched. Meanwhile, the moving means is sufficient if it has a structure for moving the paper-stacking base 12 in parallel in the vertical direction, as it is a matter of course that the present invention is not limited by, for example, the above-described embodiment and modified example.

As shown in FIG. 1, a rectangular-plate-like vertical wall portion 12e having a slide guide opening 12e-1 is formed as being downwardly bent at the right angle at a position corresponding to a protruding portion 11b formed on the base unit 11 in a frontward portion below the undersurface of the paper-stacking base 12. A guide bar 12f is crosslinked and fixed with left and right sidewall portions that are adjacent to the recessed cutout portions 12c of the paper-stacking base 12 and that are bent in the same direction to opposite each other. Exposed end portions on both sides of the guide bar 12f are slidably guided by a vertically lengthy recessed guide portions 13a formed on the opposite faces of the supporting walls 13 of the base unit 11.

A pair of left/right stopper members 18, 18 substantially reverse L shaped are vertically mounted on a rear-side upper surface of the paper-stacking base 12. A bent tip end portion of each of the stopper members 18 is inserted into each of a pair of left/right vertically lengthy slit-like openings 14b, 14b formed in an intermediate portion of the elevating unit 14. Individual opening ends on upper and lower sides of the slit-like openings 14b are formed corresponding to ascending and descending limits that block the movement of the elevating unit 14. Thus, each opening end has a function serving as an elevation regulation portion that regulates excess elevation of the elevating unit 14. In association with the approaching operation of the bit reception plate 20, the above-described construction serves to enable the paper-stacking base 12 to perform elevation movement without leftward/rightward runout being caused. By way of example, the present embodiment presents the construction having the two stopper members 18 separately formed and arranged in parallel. However, the stopper members 18 may be formed in the form of a frame unit having a connection plate between the bent tip end portions of the individual stopper members 18.

The present embodiment has been described with reference to the illustrated example in which the paper-stacking base 12 performs elevation movement between the slide guide opening 12e-1 and guide bar 12f of the paper-stacking base 12 and the protruding portion 11b and recessed guide portions 13a of the base unit 11. However, the present invention is not limited by the illustrated embodiment. For example, the construction may be formed of cutouts, concave portions, opening portions, cylindrical portions, and the like formed on one of the base unit 11 or paper-stacking base 12, and protruding portions, insertion pins, rods, and the like formed on the other of the paper-stacking base 12 and base unit 11.

The above-described construction enables the paper-stacking base 12 to be inductively guided accurately and steadily. As a consequent, entanglements, deflection, and the like of the individual links, leftward/rightward runout, and the like can be prevented, and concurrently, smooth rotation can be accomplished, whereby the quality of the parallel link mechanisms 50 is secured for a long time. In addition, it is a matter of course that the mounting positions, mounting numbers, and the like of these members are not limited to those in the illustrated example.

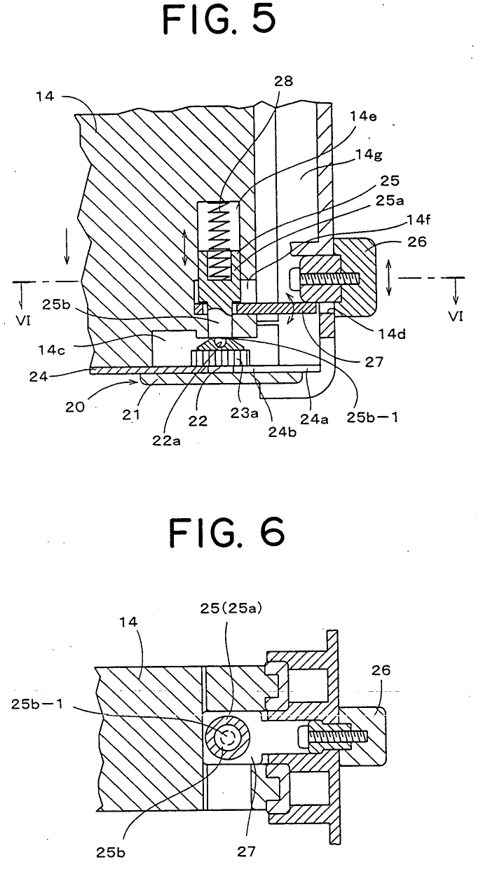

In addition, in the paper punch apparatus 10 of the present embodiment, the bit reception plate 20 is disposed insertably into and removably) from the both left and right wall portions in the lower end portion of the elevating unit 14 partly constituting an apparatus main body. FIG. 5 is a major-portion vertical cross sectional view showing a vertical cutaway of major portions of the elevating unit; and FIG. 6 is a cross sectional view taken along the line VI-VI of FIG. 5.

With reference to these drawings, the elevating unit 14 is constructed of a block unit in the form of a vertically lengthy rectangular parallelepiped. In each of both sidewall portions (front and rear faces in the direction perpendicular to FIG. 1) in the lower end portion of the elevating unit 14, a supporting plate 24 is provided such that a plate surface thereof extends parallel with a lower bottom wall of the elevating unit 14 with a predetermine gap. The supporting plate 24 constitutes an insertion/removal portion for inserting and supporting the supporting axis 22 of the bit reception plate 20 between the discoidal main body 21 and the flange portion 23. In addition, an accommodating space 14c for accommodating the flange portion 23 is formed between the elevating unit 14 and the supporting plate 24.

On the supporting plate 24, the rectangular insertion opening 24a (FIG. 10) for insertion of the supporting axis 22 of the bit reception plate 20 is formed, and a slit-like opening 24b (FIG. 10) for supporting the supporting axis 22 is formed in communication with the insertion opening 24a on the same plane. A recessed engagement portion 22a is formed on a top portion of the flange portion 23. For engagement/disengagement between the bit reception plate 20 and the supporting plate 24, a bit-reception-plate engagement/disengagement portion is used that engages/disengages with respect to the recessed engagement portion 22a in the accommodating space 14c.

The bit-reception-plate engagement/disengagement portion has an engagement/disengagement member 25 for positioning and supporting the bit reception plate 20 on the supporting plate 24, and an engagement/disengagement member manipulation portion for vertically moving the engagement/disengagement member 25. The engagement/disengagement member manipulation portion has a manipulation knob 26 and a strip-like oscillating piece 27 used for engagement/disengagement between the engagement/disengagement member 25 and the bit reception plate 20. In each of the sidewall portions (front and rear faces in the direction perpendicular to FIG. 1) in the lower end portion of the elevating unit 14, a vertically lengthy slit-like opening 14d matching the peripheral surface of the accommodating space 14c is formed. The manipulation knob 26 is fixedly mounted to the slit-like opening 14d to be vertically movable, and is resiliently supported on an upper surface of a free end portion of the oscillating piece 27.

As described above, each of the sidewall portions in the lower end portion of the elevating unit 14 has the accommodating space 14c and the supporting plate 24, and the accommodating space 14c has the engagement/disengagement member 25 for engaging/disengaging the top portion of the flange portion 23 of the bit reception plate 20. Thereby, the bit reception plate 20 is enabled to perform insertion/detachment operation with respect to the accommodating space 14c in parallel along a straight line, and the insertion/detachment of the bit reception plate 20 can be steadily and securely performed at all times.

The engagement/disengagement member 25 is formed of a large-diameter circularly cylindrical portion 25a and a small-diameter rod portion 25b. The cylindrical portion 25a and the rod portion 25b are formed along the same central axis line via a stepped face therebetween. A rod end of the rod portion 25b has a ball-like engagement protrusion 25b-1 that protrudes downwardly and that has the same shape as the engagement concave portion 22a of the bit reception plate 20 that is engageable therewith. In the lower end portion of the elevating unit 14, a vertically lengthy support space portion 14e for supporting the engagement/disengagement member 25 to be vertically movable is formed in a piercing manner. The support space portion 14e has a stepped shape having a stepped portion that has a circular support face for regulating the vertical movement of the engagement/disengagement member 25 in abutment with the stepped face thereof. The stepped face of the engagement/disengagement member 25 is positioned and resiliently supported on the circular support face of the support space portion 14e to be vertically movable in resistance with a spring force of a compression spring 28. The engagement protrusion 25b-1 of the engagement/disengagement member 25 is inserted into the recessed engagement portion 22a of the bit reception plate 20. The oscillating piece 27 is inserted across the support space portion 14e into a portion ranging from a transverse through-hole 14f, which is formed parallel with the accommodating space 14c, to a vertically lengthy manipulation space portion 14g perpendicularly merging on a vertical plane with respect to the accommodating space 14c. Thereby, the oscillating piece 27 resiliently and oscillatorily moves toward the recessed engagement portion 22a with an intermediate position of the transverse through-hole 14f as an oscillatory movement supporting point.

The engagement/disengagement member 25 is constantly urged down by the spring force of the compression spring 28. Press-down force of the compression spring 28 is received in the state where the circularly cylindrical portion 25a of the engagement/disengagement member 25 engages the circular support face of the support space portion 14e via the oscillating piece 27. In this case, the free end portion of the oscillating piece 27 causes the manipulation knob 26 to be static at a stationary position. Upon vertical sliding operation of the manipulation knob 26, oscillatory movement occurs with the intermediate position of the oscillating piece 27 as the oscillatory movement supporting point, whereby engagement is established between the recessed engagement portion 22a of the bit reception plate 20 and the engagement protrusion 25b-1 of the engagement/disengagement member 25.

As described above, the engagement/disengagement member 25 is supported so as to be oscillatorily movable in the direction perpendicular to the direction of insertion/detachment of the bit reception plate 20 whereby to bring the bit reception plate 20 into resilient engagement/disengagement. Consequently, when the manipulation knob 26 is manipulated in the lower direction perpendicular to the direction of insertion/detachment of the bit reception plate 20, the engagement between the recessed engagement portion 22a of the bit reception plate 20 and the engagement protrusion 25b-1 of the engagement/disengagement member 25 can be released.

Although the structure is simple, the bit reception plate 20 can be operated smoothly, steadily, and securely at all times. In addition, handling of the bit reception plate 20 is easy, so that the insertion/detachment of the bit reception plate 20 can be easily performed. It is a matter of course that the bit reception plate 20 can be supported so as to be transversely rotatable. To accomplish this, the spring force of the compression spring 28 for urging the engagement/disengagement member 25 in the lower direction is preliminarily set, and the recessed engagement portion 22a of the bit reception plate 20 and the engagement protrusion 25b-1 of the engagement/disengagement member 25 are engageably supported.

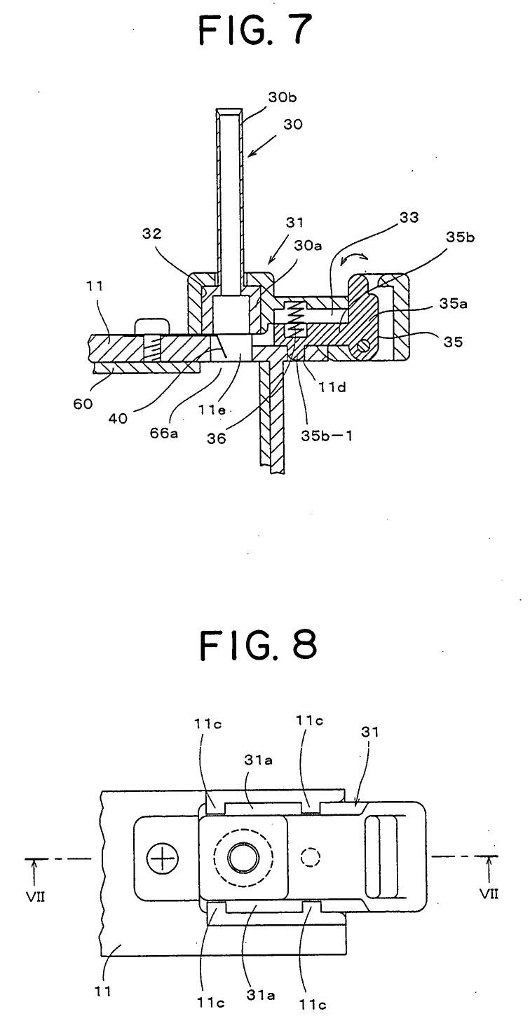

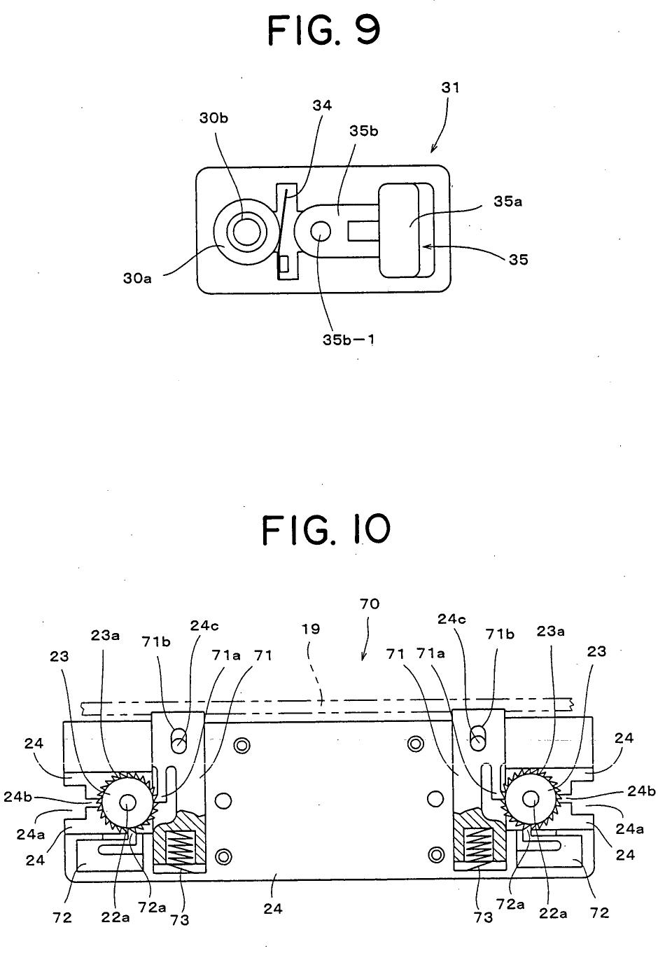

Further, in the punch apparatus 10, a hole-punch-bit support unit 31 for immobilizably supporting the hole punch bit 30 is disposed so as to be attachable and removable to the base unit 11. FIGS. 7 to 9 show an example structure of the hole-punch-bit support unit 31. FIG. 7 is a major-portion vertical sectional view showing major portions of the hole-punch-bit support unit 31 partly constituting the punch apparatus 10; FIG. 8 is a plan view of the hole-punch-bit support unit 31; and FIG. 9 is a rear view of the hole-punch-bit support unit 31. More specifically, FIG. 7 shows a cross section taken along the line VII-VII of FIG. 8.

Referring to these drawings, the hole-punch-bit support unit 31 is formed of a die-cast mould in the form of a lengthy shell unit that has wall portions formed in front and rear and left and right portions of a flat upper surface and that has an opened bottom portion. Referring to FIG. 8, as insertion/detachment guide portions for the hole-punch-bit support unit 31, a pair of front and rear guide pieces 11c, 11c are intermittently formed in the left-right direction of the base unit 11. More specifically, the guide pieces 11c each have a substantially reverse L shape and a substantially same dimension as the width of the hole-punch-bit support unit 31, and are formed in both side portions in the left-right direction (perpendicular to FIG. 1) of the base unit 11. Additionally, referring to FIG. 7, as an engagement portion of the hole-punch-bit support unit 31, an engagement/disengagement portion 11d vertically piercing is formed between the guide pieces 11c of the base unit 11.

Flanges 31a, 31a to be attached and removed with respect to the guide pieces 11c are formed in lower end edges of left and right wall portions of the hole-punch-bit support unit 31. A hole-punch-bit support portion 32 is formed inside the hole-punch-bit support unit 31 in the form of a circular cylindrical structure that has an insertion opening for inserting and supporting the proximal end portion 30a of the hole punch bit 30. In this case, the proximal end portion 30a is inserted from the lower portion of the opening. In addition, a rectangularly cylindrical insertion/detachment space portion 33 is formed in the position corresponding to the engagement/disengagement portion 11d of the base unit 11. As shown in FIG. 9, a presser bar leaf spring 34 for preventing loose-out of the hole punch bit 30 is provided in such a manner that one end thereof is fixed and a free end portion thereof resiliently abuts the proximal end portion 30a of the hole punch bit 30 thereby supporting the same.

Inside the insertion/detachment space portion 33, an oscillating member 35 having a substantially L shaped cross section is fixedly supported so as to be rotatable around a horizontal axis line with a bent portion as a rotational center. The oscillating member 35 has a rectangular-plate-like manipulation piece 35a disposed on a side of oscillatory-movement supporting point, and an engagement/disengagement member 35b extending in an oscillation direction perpendicular to the manipulation piece 35a. A compression spring 36 is interposed between a pair of upper and lower recessed portions that individually having circular cross sections and that are formed corresponding to an upper surface of the engagement/disengagement member 35b and an inner upper surface of the hole-punch-bit support unit 31. The engagement/disengagement member 35b is urged down by the spring force of the compression spring 36.

On an undersurface of an oscillating end of the engagement/disengagement member 35b, an engagement protrusion 35b-1 is formed to have a height insertable into the engagement/disengagement portion 11d of the base unit 11. When the hole-punch-bit support unit 31 is at an insertion limit position of the base unit 11, the engagement protrusion 35b-1 is resiliently inserted into the engagement/disengagement portion 11d for engagement. In this construction, when withdrawing the hole-punch-bit support unit 31 from the base unit 11, the manipulation piece 35a is pushed in the same direction as the drawing direction, whereby the engagement between the engagement/disengagement portion 11d and the engagement protrusion 35b-1 is resiliently released.

In this-construction, the engagement protrusion 35b-1 of the engagement/disengagement member 35b, which is supported to oscillate in the direction perpendicular to the insertion/detachment direction of the hole-punch-bit support unit 31, is resiliently engaged with the engagement/disengagement portion 11d. With this construction, by manipulating the manipulation piece 35a in the same direction as the withdrawal direction of the hole-punch-bit support unit 31, the engagement between the engagement/disengagement portion 11d and the engagement protrusion 35b-1 can be easily released, and exchange work therefor can be quickly performed.

As described above, since the structure of the hole-punch-bit support unit 31 can be formed to be compact, the miniaturization, reduction in size, and the like of the overall apparatus can securely be implemented. When the manipulation piece 35a is pushed in the same direction as the withdrawal direction of the hole-punch-bit support unit 31, the engagement between the engagement/disengagement portion 11d and the engagement protrusion 35b-1 can be automatically released. Thereby, although the structure is simple, the hole-punch-bit support unit 31 can be operated smoothly, steadily, and securely at all times with respect to the base unit 11, and handling thereof is very easy.

Further, as another feature portion, the paper punch apparatus 10 of the present embodiment uses a fall inhibition mechanism that inhibits falling of circular punched paper scraps (not shown) accumulating in the hole punch bit 30. As shown in FIG. 7, the fall inhibition mechanism, which is one of major mechanisms of the paper punch apparatus 10 of the present embodiment, has a leaf spring member 40.

As shown in FIG. 1, a portion of the base unit 11 is formed as being a case of which an end portion in a longitudinal direction is opened, and a space portion thereof is used as an accommodating space portion of a scrap collection receptacle 60. A punched-paper-scrap falling opening 11e communicating with the accommodating space portion of the scrap collection receptacle 60 is formed in a fixedly mounted position of the proximal end portion 30a of the hole punch bit 30 on the base unit 11. A main body side of the leaf spring member 40 tightened and fixed with a mounting screw onto the base unit 11, and a free end thereof is bent down and is interposed between the opening 11e of the base unit 11 and an opening end portion 66a on a base-unit supporting side of the hole punch bit 30.

Punched paper scraps which is pushed inside of the hole punch bit 30 and about to fall are accumulated on an upper surface of the leaf spring member 40, whereby falling of punched paper scraps can be inhibited by the spring force of the leaf spring member 40. As paper-hole punching operations are repeatedly performed and a predetermined quantity of punched paper scraps is accumulated, the punched paper scraps accumulated in the hole punch bit 30 overcome the spring force of the leaf spring member 40 whereby causing the free end portion of the leaf spring member 40 to deflect down. While causing the leaf spring member 40 to deflect down, the punched paper scraps push the leaf spring member 40 downwardly, and fall from the opening a base end side of the hole punch bit 30. The fallen punched paper scraps are directly stored into the scrap collection receptacle 60.

Thus, the hole punch bit 30 is fixedly mounted to the base unit 11, and falling of punched paper scraps accumulating in the hole punch bit 30 can be inhibited through the leaf spring member 40. Consequently, at the time of, for example, hole punch operation, exchanging of the hole punch bit 30, or withdrawal of the scrap collection receptacle 60, punched paper scraps accumulating in the hole punch bit 30 can be prevented from falling and scattering to the outside from the opening on a side of the proximal end portion of the hole punch bit 30.

Thereby, for example, punched paper scraps accumulating in the hole punch bit 30 can be prevented from scattering to the outside and from adhering to peripheral mechanisms such as the approaching/detaching means whereby deteriorating the operability thereof. Consequently, the paper-stacking base 12, a work table (not shown) can be maintained cleaned at all times. Further, the operability of the apparatus can be enhanced to perform the paper hole punch operation quickly and easily.

Further, in the accommodating space 14c formed between the supporting plate 24 and the elevating unit 14, the punch apparatus 10 of the present embodiment has an automatic rotation mechanism 70 that rotates the bit reception plate 20 by a predetermined angle in association with a vertical movement of the elevating unit 14. FIG. 10 is a major-portion transverse sectional view of a transverse cutaway of major portions of the automatic rotation mechanism 70 for the bit reception plate 20. More specifically, the FIG. 10 schematically shows an interior construction of the automatic rotation mechanism 70.

Referring to the drawing, the automatic rotation mechanism 70 for the bit reception plates 20 has a pair of left and right rectangular-plate-like engagement/disengagement members 71, 71 disposed on the same plane as the flange portions 23 of the bit reception plates 20 on the supporting plate 24, and detent members 72, 72 for the bit reception plates 20 that are disposed perpendicular to an engagement/disengagement members 71. On the each side, a lengthy opening 71b is formed in the engagement/disengagement member 71, and the lengthy opening 71b is engaged with a protruding pin 24c formed to extend on an upper surface of the supporting plate 24.

A resilient engagement detent 71a extending along a rotational direction of the gear 23a is provided to a sidewall of the engagement/disengagement member 71 that opposes the gear 23a formed on an outer circumference of the flange portion 23 of the bit reception plate 20. A tip engagement face of the resilient engagement detent 71a engages the gear 23a. The engagement/disengagement member 71 is formed to be resiliently pushed to the elevating unit 14 by a cam surface of a cam plate 19, which is shown in FIGS. 1 and 3 and is fixedly mounted between the opposite faces of the individual supporting walls 13.

Accordingly, in association with the vertical movement of the elevating unit 14, the tip engagement face of the resilient engagement detent 71a moves in the direction of engagement with the gear 23a. Thereby, the tip engagement face engages the gear 23a. Further, the resilient engagement detent 71a is pushed by the cam surface of the cam plate 19 to move down as viewed in FIG. 10. Thereby, the gear 23a is rotated by one pitch, and the bit reception plate 20 can be rotated by one pitch through the gear 23a.

On the sidewall opposing the gear 23a of one of the detent members 72, a resilient engagement detent 72a extending to the opposite side of the gear rotation direction is provided, and a tip engagement face of the resilient engagement detent 72a is engaged with the gear 23a that stops backward rotation of the gear 23a. In the engagement/disengagement member 71, a compression spring 73 provided between the engagement/disengagement member 71 and the supporting plate 24, whereby the engagement/disengagement member 71 is outwardly urged to the elevating unit 14 at all times by the spring force of the compression spring 73. The spring force of the compression spring 73 is received by the lengthy opening 71b of the engagement/disengagement member 71, whereby the gear 23a is held in a static state.

It is now assumed that the elevating unit 14 is descended. In this case, the engagement/disengagement member 71 is moved to leave from the cam plate 19 fixedly mounted between the opposite faces of the individual supporting walls 13, and is then outwardly urged by the spring force of the compression spring 73. Even at this event, the resilient engagement detent 72a of the detent member 72 is still engaged with the gear 23a. For this reason, while the resilient engagement detent 71a of the engagement/disengagement member 71 is being resiliently deflected in an extension direction to release the engagement with the gear 23a, the gear 23a passes the tip engagement face of the resilient engagement detent 71a of the engagement/disengagement member 71. The deflection resisting the resilience of the resilient engagement detent 71a resiliently returns to a portion between ring gears, and the engagement is established between the gear 23a and the resilient engagement detent 71a. In this engagement state, further rotation is stopped, and the rotation of the bit reception plate 20 is automatically stopped.

Conversely, when the elevating unit 14 is ascended, the engagement/disengagement member 71 is resiliently urged by the cam surface of the cam plate 19 to the inside of the elevating unit 14. In this event, the resilient engagement detent 72a of the detent member 72 leaves the gear 23a, and the engagement state between the detent member 72 and the gear 23a is released. At the event of the release, the resilient engagement detent 71a of the engagement/disengagement member 71 pushes the gear 23a, thereby causing the bit reception plate 20 to automatically rotate by one pitch at a predetermined rotation angle.

According to the prior art disclosed in the above-described publication, the bit reception plate downwardly separated from the operating handle is placed and supported on the paper-stacking base. Therefore, for arranging the structure to rotate the bit reception plate by a predetermined angle, an intricate interlocking mechanism should be provided to perform interlocked operation of the operating handle and the bit reception plate. In comparison, however, the present embodiment has the construction that rotates the bit reception plate 20 at the predetermined angle in association with the vertical movement of the bit reception plate 20. Therefore, an intricate interlocking mechanism such as the conventional one can be avoided, and a compact construction can be implemented by integrally disposing the simply structured automatic rotation mechanism 70 on the same plane as the bit reception plate 20.

Although the present embodiment is described with reference to the illustrated example structure of the automatic rotation mechanism 70 having the gears 23a and the resilient engagement detents 71a, the construction is not limited to the illustrated example. The construction may be of any type inasmuch as the construction is capable of rotating the bit reception plate 20 and is engageable/disengageable with respect to the bit reception plate 20, so that it is not limited to a specific type.

For the engagement/disengagement member, various structures having, for example, a ratchet detent or the like similar to the resilient engagement detent may be employed. The gear 23a may be formed on a periphery of the bit reception plate 20. For the engagement/disengagement member 71, an operational detent of a general type for resilient engagement/disengagement with respect to a ratchet tooth may be used.

Accordingly, the engagement/disengagement member 71 may be of a structure close to a simple rectangular plate piece, so that it need not be formed into an intricate structure. Since an intricate interlocking mechanism can be avoided, reduction of costs such as assembly costs, manufacturing costs, and material costs can be implemented in conjunction with the reduction of components of the automatic rotation mechanism. In addition, miniaturization, reduction in size, weight reduction, thickness reduction of the overall apparatus can be implemented. Further, with the automatic rotation mechanism being employed, while the structure is simple, the paper punch position, punch hole size, pattern, and the like can be accurately and stably ensured at all times. Thereby, the quality of, for example, the bit reception plate and hole punch bit can be enhanced, and safety, reliability, and the like thereof in use time can be significantly improved. Further, handling thereof can be made easy.

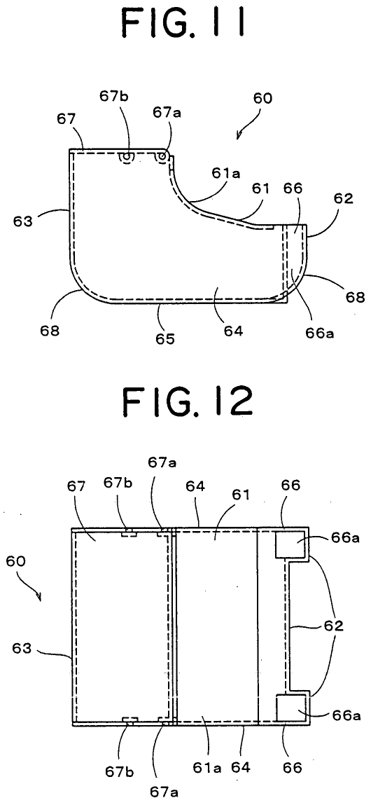

The paper punch apparatus 10 of the present embodiment has the scrap collection receptacle 60 of a synthetic resin for collecting punched paper scraps discharged from a cylinder in the proximal end portion of the hole punch bit 30. The scrap collection receptacle 60 is accommodated in a receptacle accommodation space of the base unit 11 to be attachable and removable. FIGS. 11 and 12 show the scrap collection receptacle.

With reference to these drawings, the scrap collection receptacle 60 has flat upper wall surfaces on a withdrawal side and an insertion side in front and rear portions of an arcuately concave circular arc upper surface 61a. The scrap collection receptacle 60 comprises a ceiling wall portion 61, front and rear sidewall portions 62 and 63, left and right sidewall portions 64, 64 and a bottom wall portion 65. In corner portions of a front sidewall portion 62 and the left and right sidewall portions 64 of the scrap collection receptacle 60, a pair of left and right expansion portions 66, 66 each having a cross section arcuate toward the bottom wall of the bottom wall portion 65. Upper surfaces of the expansion portions 66 are used as punched paper scrap inlets 66a formed rectangularly.

When the scrap collection receptacle is mounted, an inlet 66a is situated immediately below the opening 11e of the base unit 11, which is formed corresponding to the opening end portion of the proximal end portion 30a of the hole punch bit 30. Consequently, punched paper scraps accumulating in the hole punch bit 30 is pushed, and concurrently, can be caused to directly fall into the scrap collection receptacle 60. Thereby, such cases do not occur in which punched paper scraps fall and scatter in peripheral portions of the paper-stacking base 12, make portions such as paper-stacking base 12 and work table to be unclean, and adhere to peripheral mechanisms whereby deteriorating operabilities thereof.

An upper wall surface on the withdrawal side of the ceiling wall portion 61 is formed of an open/close lid unit 67 which opens/closes in the vertical direction. The open/close lid unit 67 is supported on the left and right sidewall portions 64 adjacent to an apex of the concave circular arc upper wall surface 61a of the ceiling wall portion 61 to be rotatable via hinge portions 67a, and fixedly mounted via engagement portions 67b to be openable and closable. An engagement portion 67b is formed of an engagement recessed portion formed in one of the open/close lid unit 67 and the left and right sidewall portions 64, and a protruding portion formed in the other one of the left and right sidewall portions 64 and the open/close lid unit 67.

The front and rear sidewall portions 62 and 63, corner portions 68 of the left and right sidewall portions 64 and bottom wall portion 65, and the concave circular arc upper surfaces 61a are formed into curved faces arcuately formed in concave states. Inside of the scrap collection receptacle 60 is formed so as to gradually expand from a side of the punched-paper-scrap inlet 66a to a side of the open/close lid unit 67.

The inside of the scrap collection receptacle 60 is formed by being completely covered by the ceiling wall portion 61, except the punched-paper-scrap inlets 66a, so as not to be exposed to the outside. This enables to prevent such cases in which, at the time of carrying the apparatus and at the time of withdrawing the scrap collection receptacle 60, punched paper scraps stored in the scrap collection receptacle 60 scatter and make a work table and peripheral portions of the work table to be unclean, and adhere to peripheral mechanisms whereby deteriorating operabilities thereof.

Further, as described above, the inside of the scrap collection receptacle 60 is formed into curved faces arcuate to the side of the open/close lid unit 67. Therefore, punched paper scraps collected into the scrap collection receptacle 60 from an undersurface opening end portion of the proximal end portion 30a of the hole punch bit 30 can be moved smoothly, easily, and securely to the side of the open/close lid unit 67 from the side of the punched-paper-scrap inlet 66a. Consequently, when the scrap collection receptacle 60 has become full, agglomerated punched paper scraps push up the open/close lid unit 67 with the hinge portions 67a as a rotation center. Thereby, punched paper scraps can be prevented from being jammed in the hole punch bit 30, and hence the hole punch bit 30 can be prevented from, for example, being deformed and damaged.

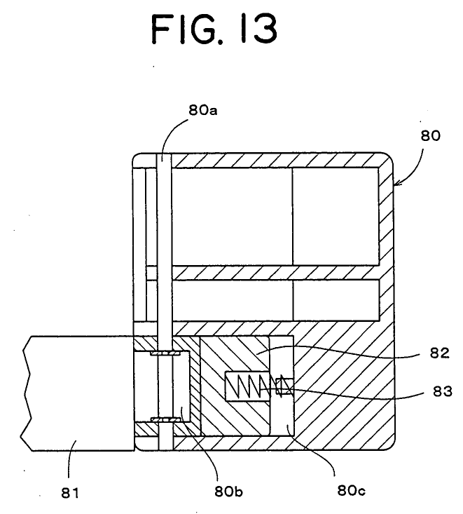

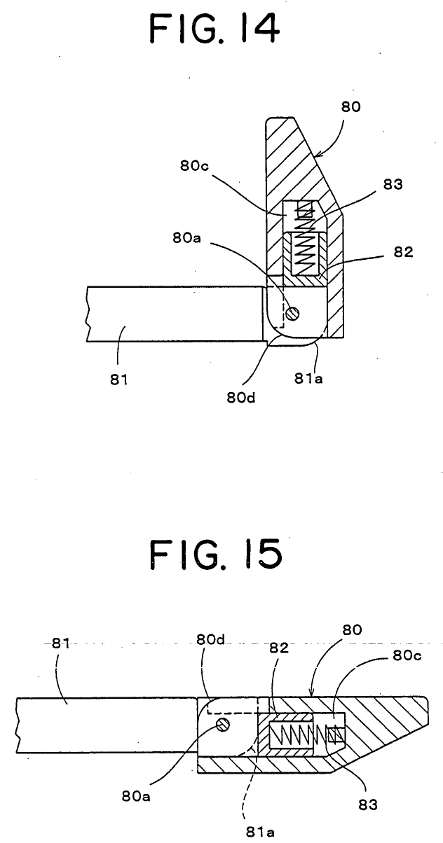

The punch apparatus 10 according to the present embodiment further has on the paper-stacking base 12 a paper abutment member 80 that enables the paper punch position to be arbitrarily changed. FIGS. 13 to 15 show an example of the paper abutment member 80. FIG. 13 is a transverse sectional view schematically showing the paper abutment member 80; FIG. 14 is a major-portion vertical sectional view schematically showing an erected state of the paper abutment member 80; and FIG. 15 is a major-portion vertical sectional view schematically showing a laid-down state of the paper abutment member 80.

With reference to these drawings, in both left and right side end portions of the paper-stacking base 12, a pair of front and rear side gauge racks 81 engaging a common pinion (not shown) are disposed so as to be movable to opposite directions to each other in the left and right directions of the base unit 11. On an edge face of a side gauge rack 81, the paper abutment member 80 is supported rotatably in a direction perpendicular to the side gauge rack 81 via a supporting axis 80a.

In the paper abutment member 80, a recessed insertion opening 80b for accommodating an end of the side gauge rack 81 is formed, and a plan-view rectangular space portion 80c continuing from one side of the insertion opening 80b to an axis line in a longitudinal direction of the side gauge rack 81 is formed. In the rectangular space portion 80c, there is accommodated via a compression spring 83 a stopper member 82 that is in resilient abutment with the edge face of the side gauge rack 81 so as to position the paper abutment member 80 at two positions: an erection position perpendicular to the side gauge rack 81 and a lay-down position along the axis line in the longitudinal direction of the side gauge rack 81.

As shown in FIGS. 14 and 15, a lower end corner portion of an end portion of the side gauge rack 81 has a first rotation guide face 81a of the paper abutment member 80, and the paper abutment member 80 has a second rotation guide face 80d with respect to the side gauge rack 81. Each of the first and second rotation guide faces 80d and 81a has an arcuate-face shaped cross section with the supporting axis 80a in a center, and is formed such that the paper abutment member 80 smoothly rotates with respect to the side gauge rack 81.

When the paper abutment member 80 rotates from a laid-down state to an erection direction perpendicular to the side gauge rack 81, the paper abutment member 80 is erected in a state of being pushed on the edge face of the side gauge rack 81 in resistance with the spring force of the compression spring 83.

More specifically, when the stopper member 82 passes over an upper-end corner portion of the side gauge rack 81, the paper abutment member 80 is synchronously engaged with an end-portion upper face of the side gauge rack 81 via the compression spring 83. In this engagement state, even when trying to further rotate the paper abutment member 80, the stopper member 82 abuts the end-portion upper face of the side gauge rack 81 and the further rotation of the paper abutment member 80 is regulated.

In the paper abutment structures, a pair of side gauge racks 81 are disposed movably to the opposite directions to each other in the right and left directions of the base unit 11, so that the center of to-be-punched paper can be positioned. In addition, the paper abutment member 80 of each side gauge rack 81 can be independently positioned via the stopper member 82 at the two positions: the erection position perpendicular to the side gauge rack 81 and the lay-down position along the axis line in the longitudinal direction thereof.

Accordingly, regardless of a size of to-be-punched paper, holes can be formed by arbitrarily choosing, for example, same punch positions and number of punch holes with an upper edge or a lower edge of paper as a reference. Consequently, paper sheets can be bound in a desired arrangement pattern. For example, papers can be arranged and bound in a file, for example, in a pattern in which lower edges of A4-size paper sheets and B5-size paper sheets are aligned, or upper edges of A4-size paper sheets and B5-size paper sheets are aligned.

Clear from the above description, the punch apparatus 10 of the present embodiment is constructed as follows. Since the parallel link mechanism 50 is present by way of paper-stacking-base moving means, at the time of approach of the bit reception plate 20 with respect to the hole punch bit 30, the paper-stacking base 12 can be smoothly moved in the horizontal and parallel state in the same direction as the movement direction of by the pressure force of the bit reception plate 20. Accordingly, while an arbitrary number of paper sheets placed on the paper-stacking base 12 are intensively vertically clamped between the bit reception plate 20 and the paper-stacking base 12, the paper sheets can be abutted linearly with respect to the upper-end bit tip portion of the hole punch bit 30.

Accordingly, positional error of the paper punch position can be prevented, and paper resistance with the hole punch bit 30 can be significantly reduced, so that linearly aligned binding holes can be formed into the paper.

Further, the tubular hole punch bit 30 is disposed immobilizably with respect to the base unit 11, and the moving means disposed approachably and detachably with respect to the upper-end bit tip portion of the hole punch bit 30 is provided in the paper punch apparatus. Thereby, while securing the performances of the mechanisms such as a bit-reception-plate insertion/detachment mechanism, hole-punch-bit attachment/removal mechanism, punched-paper-scrap fall inhibition mechanism, bit-reception-plate automatic rotation mechanism, scrap collection receptacle, and paper-abutment-member laying mechanism, the degrees of design freedom therefor can be enhanced.

The present invention is not limited to, for example, the embodiments and modified examples described above, but it is intended to include the range of techniques that may easily be modified by those concerned in the art from the embodiments and modified examples.

1. A paper punch apparatus for forming a document binding hole(s) into one or more paper sheets between a bit reception plate and a tubular hole punch bit, wherein
a lower end of the hole punch bit is fixed to a base unit, and an upper-end bit tip portion of the hole punch bit is disposed so as to pierce a paper-stacking base,
an elevating unit disposed in an opposite position to an upper end of the hole punch bit and performing vertical movement is provided,
the elevating unit accommodates in a lower end portion thereof the bit reception plate disposed in opposition to the upper-end bit tip portion of the hole punch bit, and comprises an approaching/detaching means for causing the bit reception plate to perform approaching/detaching operation with respect to the bit tip portion, and
the paper-stacking base comprises a moving means that moves along a movement direction of the bit reception plate in cooperation with an approaching operation of the bit reception plate.

2. The paper punch apparatus according to claim 1, wherein the moving means of the paper-stacking base comprises first and second parallel link mechanisms and return spring means for the parallel link mechanisms.

3. The paper punch apparatus according to claim 1, further comprising a fall inhibition mechanism that is provided in an opening end portion on a base-unit support side of the hole punch bit and that inhibits falling of punched paper scraps accumulating in a cylinder of the hole punch bit.

4. The paper punch apparatus according to claim 3, wherein the fall inhibition mechanism is formed of a leaf spring member.

5. The paper punch apparatus according to claim 1, wherein the approaching/detaching means comprises the elevating unit for supporting the bit reception plate, and an operation portion for vertically moving the elevating unit with respect to the upper-end bit tip portion of the hole punch bit.
